(19) United States
(12) Patent Application Publication
(10) Pub. No.: US 2025/0023143 A1
(43) Pub. Date: Jan. 16, 2025

(54) COOLING PLATE AND BATTERY PACK INCLUDING THE SAME

(71) Applicants: CPS Technology Holdings LLC, New York, NY (US); Clarios Advanced Solutions GmbH, Hannover (DE)

(72) Inventors: Tao ZHANG, Shanghai (CN); Chang LIU, Shanghai (CN); Marco JANSEN, Lower Saxony (DE); Joerg BIRKHOLZ, Lower Saxony (DE)

(21) Appl. No.: 18/714,384

(22) PCT Filed: Nov. 17, 2022
(86) PCT No.: PCT/IB2022/061060

§ 371 Date: May 29, 2024

(30) Foreign Application Priority Data
Dec. 1, 2021 (CN) 202111450704.5

(51) Int. Cl. H01M 10/6555; H01M 10/613; H01M 10/625; H01M 10/656; H01M 50/209; H01M 50/289

(52) U.S. Cl. CPC H01M 10/6555; H01M 10/613; H01M 10/625; H01M 10/656; H01M 50/209; H01M 50/289; H01M 2220/20

(57) ABSTRACT

The present disclosure discloses a cooling plate, comprising: a cooling plate body, an inlet pipe and an outlet pipe. The cooling plate body has a first side plate, a second side plate and a fluid channel. The first side plate and the second side plate being disposed facing each other, and a cavity being formed between the first side plate and the second side plate. The fluid channel being provided in the cavity between the first side plate and the second side plate. The fluid channel having an inlet and an outlet. The inlet pipe is in fluid communication with the inlet of the fluid channel, and the outlet pipe is in fluid communication with the outlet of the fluid channel. The first side plate, the second side plate and the fluid channel in the cooling plate body are integrally formed by extrusion.

### TECHNICAL FIELD

The present disclosure relates to a cooling plate, and more particularly, to a cooling plate for use in a battery pack comprising a plurality of battery units for a hybrid vehicle.

### BACKGROUND

In order to improve fuel consumption efficiency, in addition to requiring a conventional gasoline engine as a power source, a hybrid vehicle also needs to use a battery pack comprising a plurality of battery units as a power source. These battery units are arranged in order in a housing and are electrically connected to one another in a certain way. The battery pack generally further includes a cooling plate configured to take away heat released by the battery units during operation to cool the battery units for preventing an adverse effect of overheating of the battery pack. In general, to achieve greater voltage and current output, it is necessary to use a greater number of battery units. In this way, the volume of the battery pack will be increased, and the battery units will also release more heat during operation. However, the space inside the vehicle is very limited, so the battery pack is required to have both a compact structure and an excellent performance of preventing overheating.

### SUMMARY OF EMBODIMENTS OF THE DISCLOSURE

At least one objective of a first aspect of the present disclosure is to provide a cooling plate as described below. The cooling plate comprising a cooling plate body, an inlet pipe and an outlet pipe. The cooling plate body comprising a first side plate, a second side plate and a fluid channel. The first side plate and the second side plate being disposed facing each other, and a cavity being formed between the first side plate and the second side plate. The fluid channel being provided in the cavity between the first side plate and the second side plate. The fluid channel having an inlet and an outlet. The inlet pipe is in fluid communication with the inlet of the fluid channel, and the outlet pipe is in fluid communication with the outlet of the fluid channel. The first side plate, the second side plate and the fluid channel in the cooling plate body are integrally formed by extrusion.

According to the first aspect, the first side plate and the second side plate are made of a 5 series aluminum material.

According to the first aspect, the cooling plate body further comprises a plurality of partition plates, the plurality of partition plates being laterally disposed in the cavity between the first side plate and the second side plate and configured to form the fluid channel in a curved shape between the first side plate and the second side plate; wherein the plurality of partition plates, the first side plate and the second side plate are integrally formed by extrusion.

According to the first aspect, the cooling plate body further comprises a front sealing plate connected to front ends of the first side plate and the second side plate and a rear sealing plate connected to rear ends of the first side plate and the second side plate, wherein the plurality of partition plates include a top partition plate, at least one intermediate partition plate and a bottom partition plate, the top partition plate and the bottom partition plate being both connected to the front sealing plate and the rear sealing plate, and the at least one intermediate partition plate is connected to one of the front sealing plate and the rear sealing plate and spaced apart from the other of the front sealing plate and the rear sealing plate, so that the plurality of partition plates form the fluid channel in a curved shape between the first side plate and the second side plate.

According to the first aspect, the rear sealing plate comprises an inlet hole matching the shape of the inlet of the fluid channel and being in fluid communication with the inlet of the fluid channel, and an outlet hole matching the shape of the outlet of the fluid channel and being in fluid communication with the outlet of the fluid channel.

According to the first aspect, the front ends of the first side plate and the second side plate have respective front end faces, the rear ends of the first side plate and the second side plate have respective rear end faces, and the front sealing plate and the rear sealing plate are respectively connected to the front end faces and the rear end faces of the first side plate and the second side plate by means of a laser welding process.

According to the first aspect, the cooling plate further comprises a first adapter and a second adapter, through which the inlet pipe and the outlet pipe are respectively in fluid communication with the inlet and outlet of the fluid channel, wherein the first adapter and the second adapter respectively have a first adapter channel and a second adapter channel, wherein a first end of the first adapter channel matches the shape of the inlet of the fluid channel, and a second end of the first adapter channel matches the shape of the inlet pipe; and a first end of the second adapter channel matches the shape of the outlet of the fluid channel, and a second end of the second adapter channel matches the shape of the outlet pipe.

According to the first aspect, the first adapter and the second adapter are connected to the rear scaling plate by means of a laser welding process, and are connected to the inlet pipe or the outlet pipe by means of a laser welding process.

According to the first aspect, the cooling plate further comprises an end plate, wherein the end plate extends perpendicular to the first side plate and the second side plate, and the end plate is connected to at least one of the first adapter, the second adapter, the inlet pipe and the outlet pipe by means of a laser welding process.

According to the first aspect, the end plate comprises sleeve tubes, through which the end plate is connected to the first adapter, the second adapter, the inlet pipe and the outlet pipe.

According to the first aspect, the cooling plate is mounted in a battery pack which comprises: a plurality of battery units including a first group of battery units in contact with the first side plate of the cooling plate and a second group of battery units in contact with the second side plate of the cooling plate.

At least one objective of a second aspect of the present disclosure is to provide a battery pack. The battery pack comprising: a housing, a cooling plate according to any implementation of the first aspect, and a plurality of battery units. The housing having a chamber. The cooling plate being disposed in the chamber in a front-rear direction. The plurality of battery units including a first group of battery units which are in contact with the first side plate of the cooling plate and disposed in the chamber on a first side of the cooling plate, and a second group of battery units which are in contact with the second side plate of the cooling plate and disposed in the chamber on a second side of the cooling plate.

Other features, advantages and embodiments of the present disclosure may be elaborated or become apparent by considering the following specific embodiments, accompanying drawings and claims. Furthermore, it should be appreciated that the above summary and the following detailed description of embodiments are all exemplary, and are intended to provide a further explanation, but not to limit the scope of protection of the present disclosure. However, the detailed description of embodiments and specific examples merely indicate preferred embodiments of the present disclosure. For those skilled in the art, various variations and modifications within the spirit and scope of the present disclosure will become apparent by the way of the detailed description of embodiments.

### BRIEF DESCRIPTION OF THE DRAWINGS

FIGS. 1A and 1B are structural perspective views of a battery pack according to the present disclosure in two orientations;

FIGS. 2A and 2B are exploded views of the battery pack in FIG. 1A in two orientations;

FIG. 2C is a cross-sectional view of the battery pack in FIG. 1A;

FIG. 3A is a structural perspective view of a cooling plate in FIG. 1A according to an embodiment of the present disclosure;

FIG. 3B is an exploded view of the cooling plate in FIG. 3A;

FIG. 3C is a partial side view of the cooling plate in FIG. 3A;

FIG. 4A is a structural perspective view of a cooling plate according to another embodiment of the present disclosure;

FIGS. 4B and 4C are exploded views of the cooling plate in FIG. 4A in two orientations; and

FIG. 4D is a cross-sectional view of the cooling plate in FIG. 4A.

### DETAILED DESCRIPTION OF EMBODIMENTS

Various specific implementations of the present disclosure will be described below with reference to the accompanying drawings which constitute part of this description. It should be understood that although the terms for indicating orientations, such as “front”, “rear”, “upper”, “lower”, “left”, “right”, “top”, “bottom”, “inner” and “outer”, are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be arranged in different directions, these terms indicating directions are merely illustrative and should not be considered as limitations.

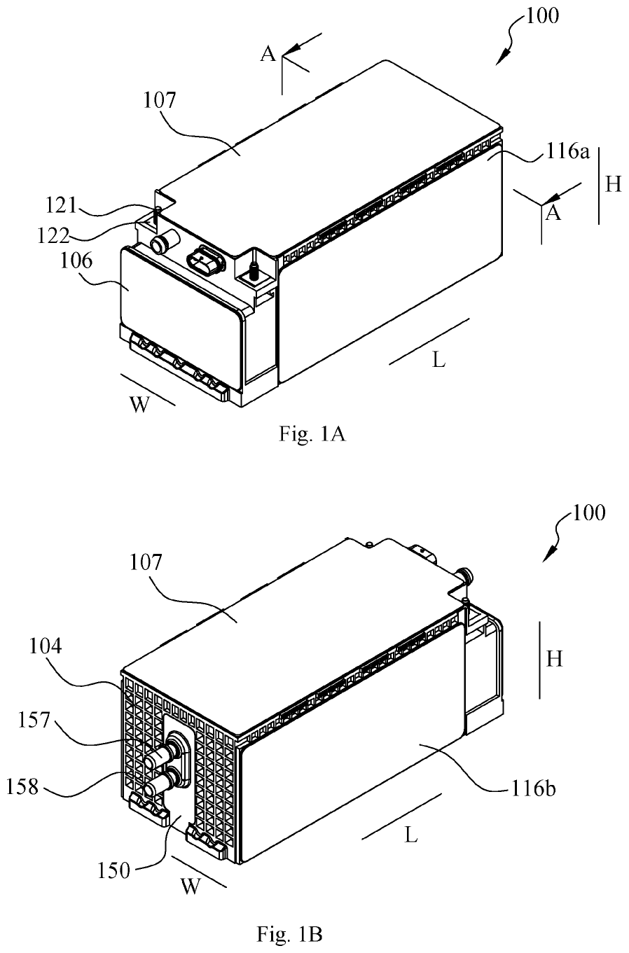

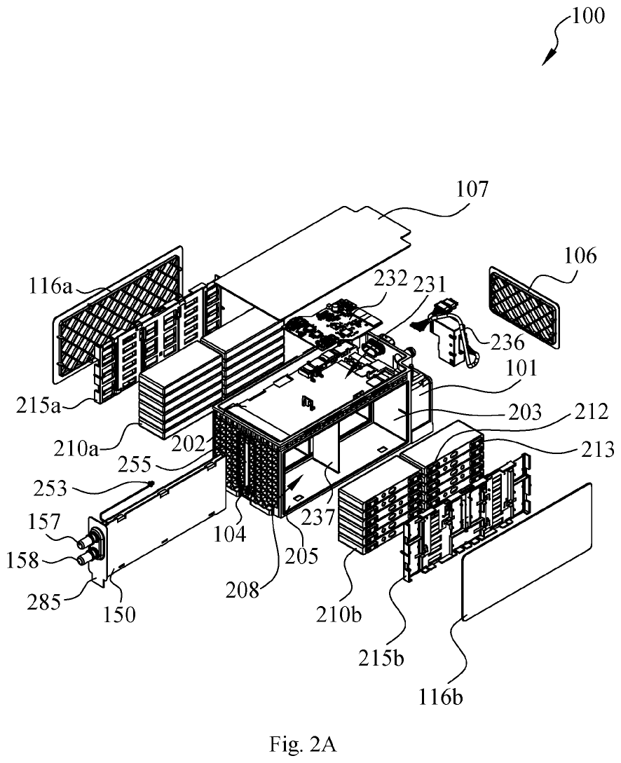

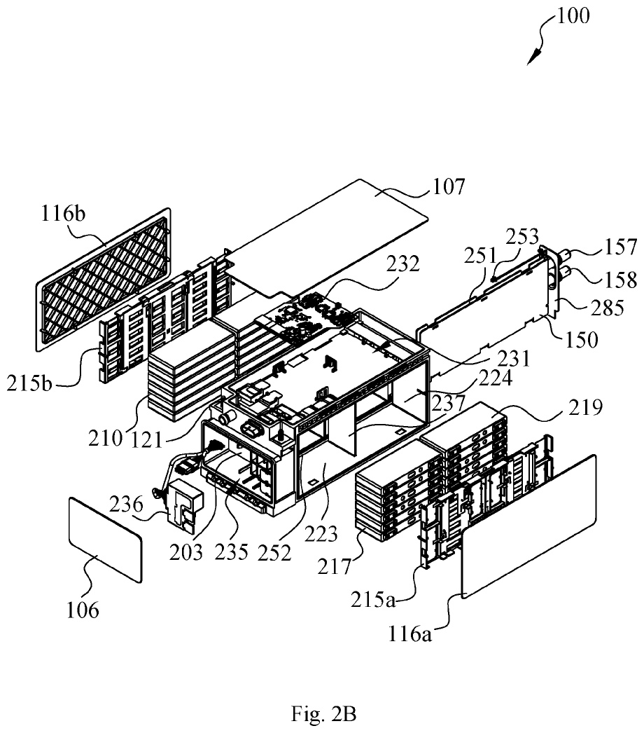

FIGS. 1A and 1B are structural perspective views of an embodiment of a battery pack 100 according to the present disclosure in different orientations from a front side and a rear side, for showing the external structure of the battery pack 100. As shown in FIGS. 1A and 1B, the battery pack is substantially in the shape of a cuboid, and includes a housing 101. The housing 101 has a length direction L, a width direction W and a height direction H. The housing 101 has a top cover plate 107 and a bottom wall 205 disposed opposite to each other in the height direction H (see FIGS. 2A and 2B), has a front cover plate 106 and a rear wall 104 disposed opposite to each other in the length direction L, and has a pair of side cover plates 116a and 116b disposed opposite to each other in the width direction W. The housing 101 is internally provided with a chamber 208. The chamber 208 is used for accommodating a plurality of battery units 210 (see the chamber 208 and the battery units 210 in FIGS. 2A and 2B). A pair of recesses 122 are disposed at left and right corners of the front top of the housing 101, and a pair of terminal posts 121 are disposed in the corresponding recesses 122. The terminal posts 121 are used for connecting to a device that needs to be powered, so as to output an energy of respective battery units 210 after being electrically connected.

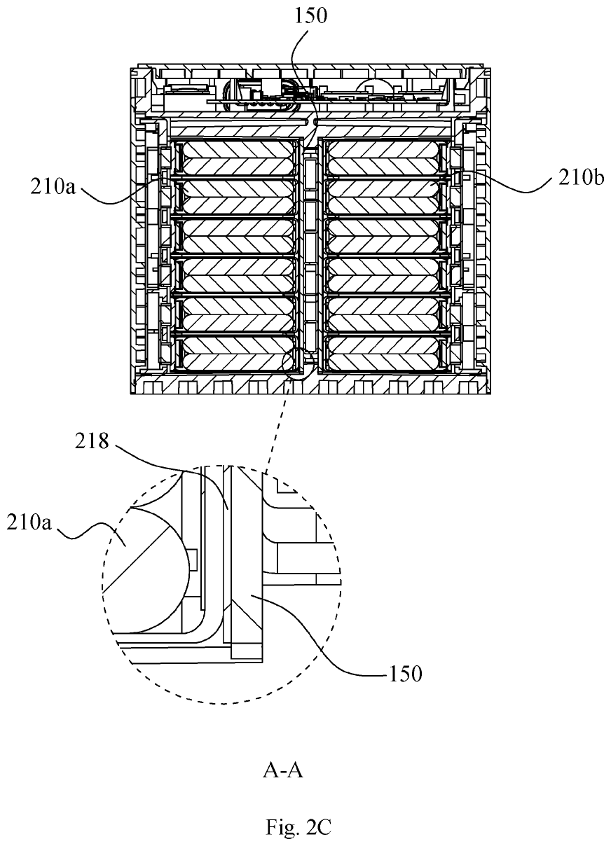

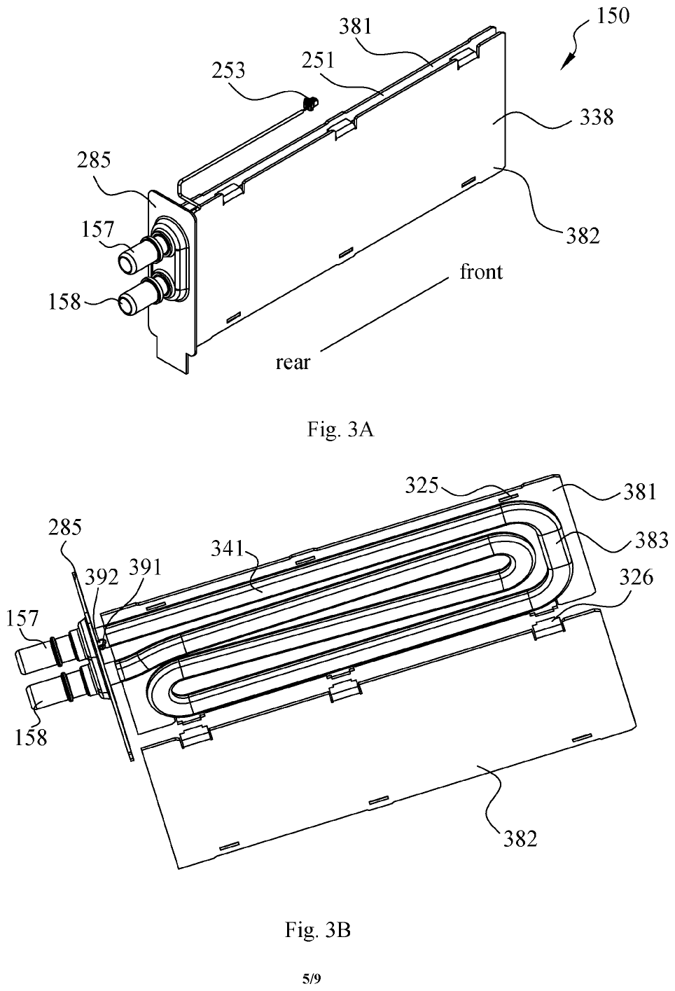

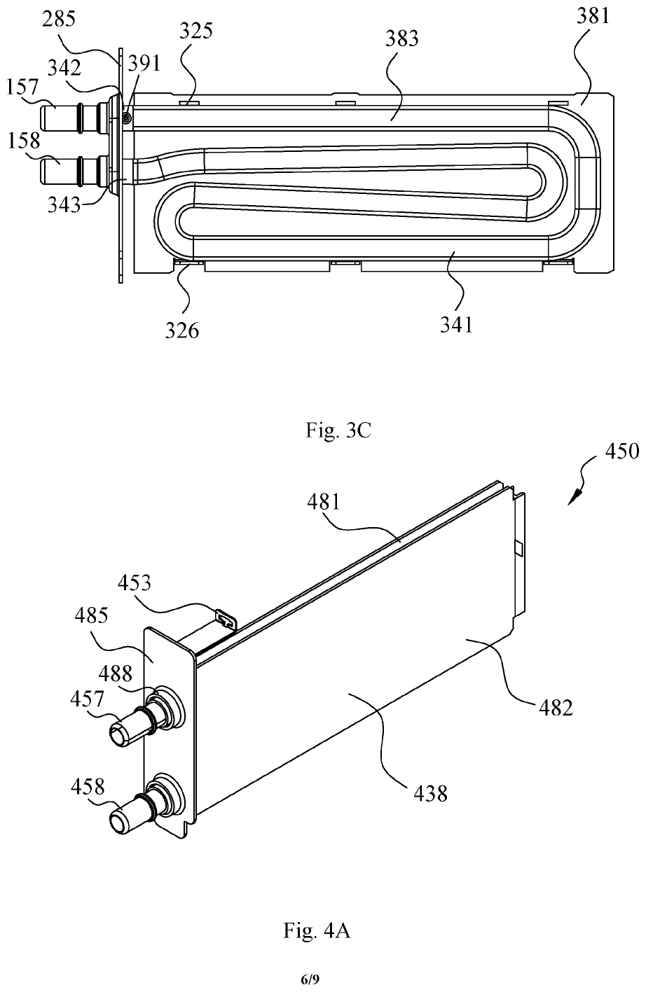

The battery pack 100 further includes a cooling plate 150. The cooling plate 150 is inserted into the housing 101 along the length direction L from the rear wall 104 for cooling the respective battery units 210 in the housing 101. A rear side of the cooling plate 150 is provided with an inlet pipe 157 and an outlet pipe 158 extending out of the rear wall 104. The inlet pipe 157 and the outlet pipe 158 are used for communicating with a cooling medium (not shown in the figures) outside the battery pack, such that the cooling medium can enter into a fluid channel 341 inside the cooling plate 150 from the inlet pipe 157 (see the specific structure of the cooling plate 150 shown in FIGS. 3A-3C), and flow out of the cooling plate 150 from the outlet pipe 158 after cooling the respective battery units 120. In various embodiments of the present disclosure, the cooling plate 150 is located approximately in the middle of the housing 101 in the width direction W, and extends along the length direction L of the housing 101. In various embodiments of the present disclosure, the cooling medium may be an active cooling medium or a passive cooling medium.

FIGS. 2A and 2B are exploded views of the battery pack 100 shown in FIG. 1A in different orientations from the front side and from the rear side, and FIG. 2C is a cross-sectional view of the battery pack 100 along the height direction, wherein a partial enlarged view is shown in a dotted circle. FIGS. 2A-2C are used to show an internal structure of the battery pack 100. As shown in FIGS. 2A-2C, the housing 101 further has a front wall 203 and a top wall 202, and the front wall 203, the bottom wall 205 and the rear wall 104 enclose the chamber 208. In this embodiment, the front wall 203, the bottom wall 205 and the rear wall 104 are integrally formed, e.g., integrally formed by molding.

The housing 101 further includes a top chamber 231 between the top wall 202 and the top cover plate 107, and the top cover plate 107 closes the top chamber 231 from above. The top chamber 231 is used to accommodate a circuit board 232. The housing 101 further includes a front chamber 235 between the front wall 203 and the front cover plate 106, and the front cover plate 106 closes the front chamber 235 from the front side. The front chamber 235 is used to accommodate a relay 236. The cooling plate 150 further includes a sensor 253. The sensor 253 is used to measure an input or output temperature of the cooling medium. In this embodiment, the sensor 253 is used to measure the input temperature of the cooling medium. The relay 236 and the sensor 253 are electrically connected to circuit board 232. The circuit board 232 is in a communication connection with an external vehicle controller or a cooling system controller (not shown), for controlling a speed and a flow of the cooling medium inputted to the cooling plate based on the temperature measured by the sensor 253.

The rear wall 104 of the housing 101 is provided with a rear side opening 255, and the cooling plate 150 is inserted forwardly into the chamber 208 in the housing 101 from the rear side opening 255, with a portion extending outside of the chamber 208 from the rear wall 104. After the cooling plate 150 is installed in place, the cooling plate 150 is supported between the top wall 202 and the bottom wall 205, dividing the chamber 208 into a chamber on a left side and a chamber on a right side in the width direction W. The cooling plate 150 closes the rear side opening 255.

The plurality of battery units 110 includes a first group of battery units 110a and a second group of battery units 110b. The first group of battery units 110a are disposed in the chamber 208 on the left side (i.e., a first side) of the cooling plate 150, and the second group of battery units 110b are disposed in the chamber 208 on the right side (i.e., a second side) of the cooling plate 150. Both left and right sides of the housing 101 form an opening in shape. The side cover 116a on the left side closes the chamber 208 from the left side, so as to enclose the first group of battery units 110a in the housing 101. The side cover 116b on the right side closes the chamber 208 from the right side, so as to enclose the second group of battery units 110b in the housing 101. In this embodiment, the first group of battery units 110a includes twelve battery units arranged side-by-side in two rows, each row including six battery units arranged in a stacked manner. Similarly, the second group of battery units 110b also includes twelve battery units arranged side-by-side in two rows, each row including six battery units arranged in a stacked manner. Each battery unit 110 is in the shape of a flat cuboid, and is stacked along the respective height direction and disposed side-by-side along the respective length direction. Each battery unit 110 includes a battery unit positive electrode 212 and a battery unit negative electrode 213, an inner side of each battery unit 110 in the width direction is attached to and in contact with the cooling plate 150, and the battery unit positive electrode 212 and the battery unit negative electrode 213 are arranged on an outer side facing away from the cooling plate 150.

On the inner side of the battery units 110, each battery unit 110 is in contact with and connected to the cooling plate 150 via a heat dissipation adhesive 218, so that the cooling plate 150 takes away the heat generated by the battery units during operation. In this embodiment, the first group of battery units 110a and the second group of battery units 110b are respectively disposed on the left and right sides of the cooling plate 150, that is, both left and right sides of the cooling plate 150 are in contact with the battery units 110. Compared with the battery pack in which a single side of the cooling plate is in contact with the battery units, the cooling plate 150 in this embodiment has a larger contact area with the battery units 110. For a battery pack of the same volume, the cooling plate 150 in this embodiment can achieve higher heat dissipation efficiency.

On the outer side of the battery units 110, the battery pack 100 further includes a pair of bus boards 215a and 215b. The bus board 215a is disposed between the first group of battery units 110a and the side cover plate 116a on the left side, and is in contact with the battery unit positive electrode 212 and the battery unit negative electrode 213 via an electrical circuit, so as to electrically connect the respective battery units 110 among the first group of battery units 110a according to a predetermined pattern, e.g., in series or in parallel. The bus board 215a is also electrically connected to the terminal post 121 on the left side, so as to output the electric energy of the first group of battery units 110a via the terminal post 121. Likewise, the bus board 215b is disposed between the second group of battery units 110b and the side cover plate 116b on the right side, and is electrically connected to the terminal post 121 on the right side, so as to output an electrical energy of the second group of battery units 110b via the terminal post 121.

In this embodiment, the housing 101 further includes a dividing plate 237. The dividing plate 237 divides the chamber 208 into a front chamber 223 and a rear chamber 224 in the length direction L. Six front battery units 217 in each group of battery units 110 are disposed in the front chamber 223, and the other six rear battery units 219 are disposed in the rear chamber 223. By providing the dividing plate 237, the battery units can be more stably fixed in predetermined positions.

Mounting rails 252 are also provided in the chamber 208 of the housing 101. In this embodiment, the mounting rails 252 are provided at corresponding positions of the top wall 202 and the bottom wall 205 of the housing 101, for example, in the middle of the housing 101 in the width direction W, and extend forwardly from a rear side opening 255 of the rear wall 104 to the front wall 203. Correspondingly, grooves 251 are provided on the top and the bottom of the cooling plate 150, and the grooves 251 also extend in a front-rear direction. The grooves 251 are disposed in cooperation with the mounting rails 252 to guide the cooling plate 150 to be inserted forwardly into the chamber 208 from the rear side opening 255 until the front of the cooling plate 150 abuts against the front wall 203 of the housing 101, and an end plate 285 at the rear of the cooling plate 150 closes the rear side opening 255. In this embodiment, a mounting rail 252 is also provided at a corresponding position of the front wall 203, and the front of the cooling plate 150 is also provided with a groove 251, so that after the cooling plate 150 is inserted into the chamber 208 in place, the front and rear sides of the cooling plate 150 can be both fixed relative to the housing 101 to prevent the cooling plate 150 from moving unexpectedly when the battery pack 100 is subject to vibration.

FIGS. 3A-3C show a specific structure of the cooling plate 150 according to a first embodiment of the present disclosure. FIG. 3A shows a perspective view of the cooling plate 150, FIG. 3B shows a partial exploded view of the cooling plate 150, and FIG. 3C shows a side view of the cooling plate 150 after a second side plate 382 is removed. In order to show an installation position of the sensor 253 more clearly, the sensor 253 is also omitted in FIGS. 3B and 3C.

As shown in FIGS. 3A-3C, the cooling plate 150 includes a cooling plate body 338 and a cooling pipe 383. The cooling plate body 338 includes a first side plate 381 and a second side plate 382, the first side plate 381 and the second side plate 382 are disposed facing each other and spaced apart from each other, and the cooling pipe 383 is sandwiched between the first side plate 381 and the second side plate 382. The cooling pipe 383 has a thickness such that the first side plate 381 and the second side plate 382 are spaced apart from each other by a distance, so that the grooves 251 can be formed at the top, the bottom and the front of the first side plate 381 and the second side plate 382. As a specific example, the top of the first side plate 381 is provided with a plurality of positioning holes 325, the top of the second side plate 382 is provided with a plurality of bent tabs 326 bent toward the positioning holes 325 at corresponding positions, and each of the bent tabs 326 can be inserted into one corresponding positioning hole 325. Similarly, the bottom of the second side plate 382 is provided with a plurality of positioning holes 325, and the bottom of the first side plate 381 is provided with a plurality of bent tabs 326 for inserting into the positioning holes 325 at corresponding positions. As a specific example, after the bent tabs 326 are inserted into the positioning holes 325, they are connected together by means of a welding process, such that the first side plate 381 and the second side plate 382 are fixedly connected together, and the cooling pipe 383 is sandwiched between the first side plate 381 and the second side plate 382.

The cooling pipe 383 has a flat tubular shape, and has a fluid channel 341 therein for circulating a cooling medium. Depending on the properties of the circulating cooling medium, the cooling pipe 383 can be bent into any desired shape to form a fluid channel of any desired shape. In this embodiment, the cooling pipe 383 is bent into a curved shape to form a curved fluid channel 341. Two sides of the cooling pipe 383 are configured to be in contact with and connected to the first side plate 381 and the second side plate 382. The flat shape facilitates increasing the contact areas between the cooling pipe 383 and the first side plate 381 and the second side plate 382, so that the stability of connection between the cooling pipe 383 and the first side plate 381 and the second side plate 382 is increased, and the efficiency of heat transfer is also increased. The fluid channel 341 has an inlet 342 and an outlet 343, and two ends of the cooling pipe 383 form the inlet 342 and the outlet 343, respectively. One end of the cooling pipe 383 at the inlet 342 is connected to the inlet pipe 157, and one end thereof at the outlet 343 is connected to the outlet pipe 158. In this way, the cooling medium can flow into the cooling pipe 383 through the inlet pipe 157, flow in the curved fluid channel 341 of the cooling pipe 383, and exchange heat with the respective battery units 110 through the first side plate 381 and the second side plate 382, and then flow out through the outlet pipe 158.

One end of the cooling pipe 383 is provided with a mounting hole 391 for mounting the sensor 253. In this embodiment, the mounting hole 391 is provided at one end of the cooling pipe 383 close to the inlet pipe 157, so that the sensor 253 can measure the input temperature of the cooling medium. In other embodiments, it is also possible that the mounting hole 391 is provided on the end of the cooling pipe 383 close to the outlet pipe 158, or mounting holes 391 are provided on two ends of the cooling pipe. The mounting hole 391 is provided in the pipe wall in the middle of the cooling pipe 383 in the radial direction, so that the measurement result of the sensor 253 is more accurate. As an example, the mounting hole 391 is formed by a cylinder 392 provided on the pipe wall, the sensor 253 extends into the mounting hole 391, and the sensor 253 is adhered to the cylinder 392 via a thermally conductive adhesive and is thus fixed thereto.

In this embodiment, in order to increase the efficiency of heat transfer, the cooling pipe 383, the first side plate 381 and the second side plate 382 are all made of a metal aluminum material, such as a 3 series aluminum material. The cooling pipe 383 is connected to the first side plate 381 and the second side plate 382 by means of a welding process, and the cooling pipe 383 is also connected to the inlet pipe 157 and the outlet pipe 158 by means of a welding process, such as a solder welding process.

The end plate 285 of the cooling plate 150 is connected to an end portion of the cooling pipe 383 for closing the rear side opening 255 on the rear wall 104 of the housing 101. The end plate 285 is disposed substantially perpendicular to the first side plate 381 and the second side plate 382. In this embodiment, the end plate 285 is also made of a metal aluminum material, and is connected to the end portions of the cooling pipe 383 by means of a welding process, or connected to the inlet pipe 157 and the outlet pipe 158.

In the battery pack 100 in this embodiment, the cooling plate 150 is disposed in the middle of the housing 101, and a plurality of battery units 110, e.g., twenty-four battery units 110 are disposed on the two sides of the cooling plate 150. This makes the structure of the battery pack 100 compact, and also increase the contact area between the battery units and the cooling plate.

Although in this embodiment, the fluid channel of the cooling plate is formed by a cooling pipe, the fluid channel may also be directly formed in other ways, such as formed by directly extruding the cooling channel and the cooling plate body integrally in some other embodiments.

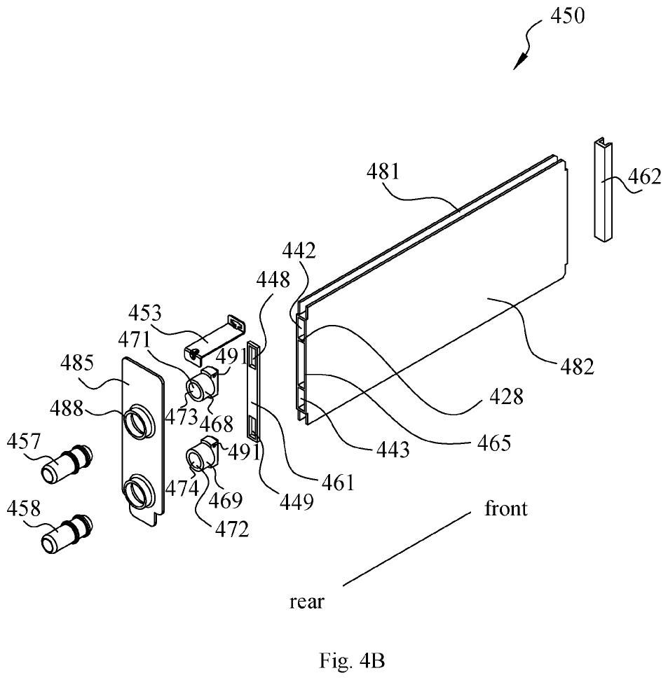

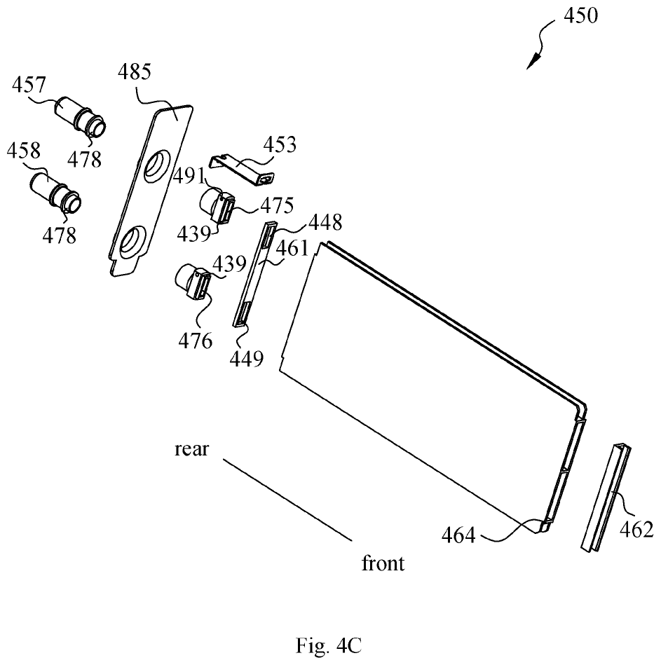

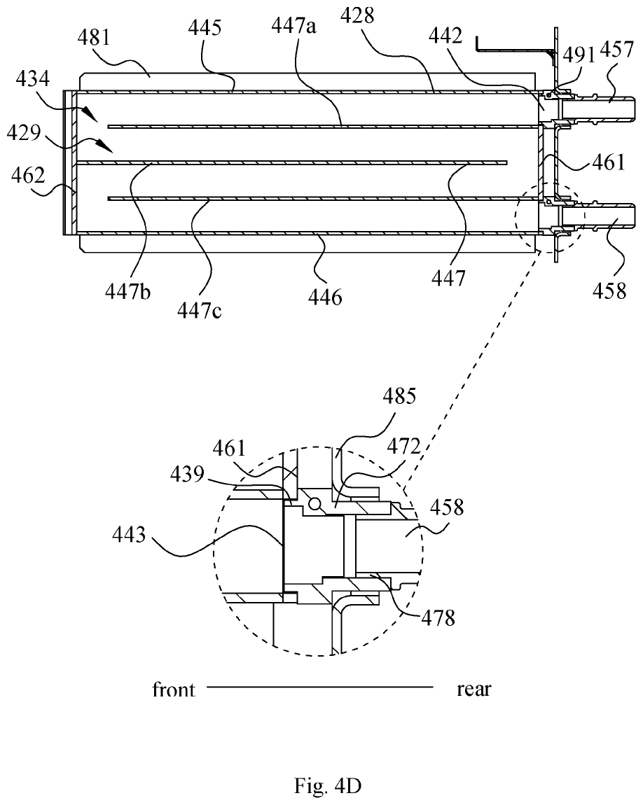

FIGS. 4A-4D show a specific structure of a second embodiment of the cooling plate 450 according to the present disclosure. FIG. 4A shows a structural perspective view of the cooling plate 450, FIGS. 4B and 4C show exploded views of the cooling plate 450 in two orientations, and FIG. 4D shows a cross-sectional view of the cooling plate 450, wherein a partial enlarged view is shown in a dotted circle.

Similar to the cooling plate 150, the cooling plate 450 is also configured to be inserted into the middle of the housing 101 through the rear side opening 255 on rear wall 104 of housing 101, as shown in FIGS. 4A-4D. The cooling plate 450 includes a cooling plate body 438, an end plate 485, an inlet pipe 457 and an outlet pipe 458. The end plate 485, the inlet pipe 457 and the outlet pipe 458 are all connected to the rear end of the cooling plate body 438. The cooling plate body 438 is internally provided with a fluid channel 441, and an inlet 442 and an outlet 443 of the fluid channel 441 are in fluid communication with the inlet pipe 457 and the outlet pipe 458, respectively. Unlike the cooling plate 150, in this embodiment, the fluid channel 441 is no longer formed by a cooling pipe, but is formed by a first side plate 481, a second side plate 482, and a plurality of partition plates 428 between the first side plate 481 and the second side plate 482.

Specifically, the cooling plate body 438 includes the first side plate 481, the second side plate 482 and the plurality of partition plates 428. The first side plate 481 and the second side plate 482 are disposed facing each other and spaced apart from each other to form a cavity 429 between the first side plate 481 and the second side plate 482. The plurality of partition plates 428 are laterally disposed in the cavity 429 and connected to the first side plate 481 and the second side plate 482 to divide the cavity 429 to form a fluid channel 441, such as the fluid channel 441 in a curved shape.

The cooling plate 450 further includes a front sealing plate 462 and a rear sealing plate 461. The front sealing plate 462 is connected to front end faces 464 of the first side plate 481 and the second side plate 482, and the rear sealing plate 461 is connected to rear end faces 465 of the first side plate 481 and the second side plate 482. As an example, the front sealing plate 462 and the rear sealing plate 461 may be connected to the front end faces 464 and the rear end faces 465 of the first side plate 481 and the second side plate 482 by means of a laser welding process. The front sealing plate 462 closes a front end of the cavity 429. The rear sealing plate 461 has an inlet hole 448 and an outlet hole 449, the rear sealing plate 461 partially closes a rear end of the cavity 429, and the inlet hole 448 and the outlet hole 449 are in fluid communication with the inlet 442 and the outlet 443 of the fluid channel 441, respectively, and are square in shape. The plurality of partition plates 428 include a top partition plate 445, three intermediate partition plates 447 and a bottom partition plate 446. Front and rear ends of the top partition plate 445 are respectively connected to the front sealing plate 462 and the rear sealing plate 461 to form a top of the fluid channel 441. Front and rear ends of the bottom partition plate 446 are respectively connected to the front sealing plate 462 and the rear scaling plate 461 to form a bottom of the fluid channel 441. The three intermediate partition plates 447 are alternatively spaced apart from the front scaling plate 462 and the rear sealing plate 461 at one end, and connected to the corresponding rear scaling plate 461 and the front sealing plate 462 at the other end. In other words, adjacent intermediate partition plates 447 are respectively spaced apart from the front sealing plate 462 or the rear sealing plate 461 to form a flow port 434 through which the cooling medium flows, thereby forming the fluid channel 441 in a curved shape. In the embodiment shown in FIG. 4D, the three intermediate partition plates 447 are the intermediate partition plates 447a, 447b and 447c in order from top to bottom. A front end of the intermediate partition plate 447a is spaced apart from the front sealing plate 462 to form a flow port 434, and a rear end of the intermediate partition plate 447a is connected to the rear sealing plate 461. A front end of the intermediate partition plate 447b is connected to the front sealing plate 462, and a rear end of the intermediate partition plate 447b is spaced apart from the rear sealing plate 461 to form a flow port 434. A front end of the intermediate partition plate 447c is spaced apart from the front sealing plate 462 to form a flow port 434, and a rear end of the intermediate partition plate 447c is connected to the rear sealing plate 461. The top partition plate 445 and its adjacent intermediate partition plate 447a form the inlet 442 of the fluid channel 441 on the rear end faces 465 of the first side plate 481 and the second side plate 482. The bottom partition plate 446 and its adjacent intermediate partition plate 447c form the outlet 443 of the fluid channel 441 on the rear end faces 465 of the first side plate 481 and the second side plate 482.

In this way, after entering into the fluid channel 441 through the inlet 442 of the fluid channel 441, the cooling medium first flows forwardly along the top partition plate 445 and the intermediate partition plate 447a to the respective flow port 434, and then flows backwardly along the intermediate partition plate 447a and the intermediate partition plate 447b to the respective flow port 434, then flows forwardly along the intermediate partition plate 447b and the intermediate partition plate 447c to the respective flow port 434, and finally flows backwardly along the intermediate partition plate 447c and the bottom partition plate 446 to flow out from the outlet 443 of the fluid channel 441. The fluid channel 441 in a curved shape formed in this way can allow the cooling medium to have a longer flow distance, and to sufficiently exchange heat with the battery units through the first side plate 481 and the second side plate 482.

The cooling plate 450 further includes a pair of adapters, namely a first adapter 468 and a second adapter 469. The adapters are used to fluidly communicate the inlet 442 and the outlet 443 of the fluid channel 441 with the inlet pipe 457 and the outlet pipe 458, respectively. This is because in this embodiment, the inlet pipe 457 and the outlet pipe 458 are round pipes in shape, while the inlet 442 and the outlet 443 of the fluid channel 441 and the inlet hole 448 and the outlet hole 449 on the rear sealing plate 461 are square in shape. Mounting holes 491 for mounting sensors are respectively provided on walls of the first adapter 468 and the second adapter 469, for mounting the sensors for measuring the input temperature and output temperature of the cooling medium. Specifically, the first adapter 468 is internally provided with a first adapter channel 471, and the second adapter 469 is internally provided with a second adapter channel 472. A front end 475 (i.e., a first end) of the first adapter channel 471 is square in shape, which is consistent with the shape of the inlet 442, and a rear end 473 (i.e., a second end) is circular in shape, which is consistent with the shape of the inlet pipe 457. A front end 476 (i.e., a first end) of the second adapter channel 472 is square in shape, which is consistent with the shape of the outlet 443, and a rear end 474 (i.e., a second end) is circular in shape, which is consistent with the shape of the outlet pipe 458. The pair of adapters and the rear sealing plate 461, and the inlet pipe 457 and the outlet pipe 458 are also connected by means of a laser welding process. In this embodiment, in order to facilitate laser welding, the front ends of the first adapter 468 and the second adapter 469 have square flanges 439 that can be inserted into the inlet hole 448 and the outlet hole 449 on the rear sealing plate 461, and are connected to inner walls of the inlet hole 448 and the outlet hole 449 on the rear sealing plate 461 by laser welding via the square flanges 439. Similarly, the front ends of the inlet pipe 457 and the outlet pipe 458 have circular flanges 478 that can be inserted into rear ends of the first adapter 468 and the second adapter 469, and are connected to inner walls of the rear ends of the first adapter 468 and the second adapter 469 by laser welding via the circular flanges 478. With the provision of the square flanges 439 and the circular flanges 478, the welding area for the laser welding process can be increased, so that the first adapter 468 and the second adapter 469 can be firmly connected between the inlet pipe 457 and the outlet pipe 458 and the rear sealing plate 461. For ease of machining, the mounting holes 491 are provided in the walls of the square portions of the first adapter 468 and the second adapter 469.

The cooling plate 450 further includes the end plate 485. Like the cooling plate 150, the end plate 485 also serves to close the rear side opening 255 on the rear wall 104 of the housing 101. The end plate 485 also has a shape substantially perpendicular to the first side plate 481 and the second side plate 482. The end plate 485 is provided with two sleeve tubes 488, and the inlet pipe 457 and the outlet pipe 458 are respectively connected to the first adapter 468 and the second adapter 469 through one of the sleeve tubes 488.

The end plate 485 is connected to the first adapter 468 and the second adapter 469 or to the inlet pipe 457 and the outlet pipe 458 via the two sleeve tubes 488. Those skilled in the art can set a desired length of the sleeve tubes 488 as required, so as to increase connection areas between the sleeve tubes 488 and the pair of adapters or the inlet pipe 457 and the outlet pipe 458.

The cooling plate 450 also includes sensors (not shown in the figures). The sensors are mounted to the first adapter 468 and the second adapter 469 through the mounting holes 491. For example, the sensors are adhered to the mounting holes 491 by a thermally conductive adhesive and extend into the mounting holes 491. The sensors are electrically connected to the circuit board 232. The sensors are used to measure the input temperature and output temperature of the cooling medium, and transmit the measurement results to the circuit board 232. Those skilled in the art may also arrange the mounting hole 491 and the sensor on only one of the first adapter 468 and the second adapter 469 according to actual requirements.

The cooling plate 450 further includes a wire fixing member 453, the wire fixing member 453 is connected to the end plate 485, for fixing and supporting wires of the sensor to be connected to the circuit board 232.

In this embodiment, the first side plate 481, the second side plate 482 and the fluid channel 441 in the cooling plate body 438 are integrally formed by extrusion. For example, the first side plate 481, the second side plate 482 and the plurality of partition plates 428 are made of a 5 series aluminum material and are integrally formed by extrusion.

The cooling plate 150 made of the 3 series aluminum material is welded by a solder welding process, and the high temperature required by the solder welding process may affect the hardness of the 3 series aluminum material to a certain extent. In this embodiment, the cooling plate 450 can be integrally formed by extrusion of the 5 series aluminum material. The hardness of the 5 series aluminum material is greater than that of the 3 series aluminum material, and the process of integrally forming by extrusion will not affect the hardness of the aluminum material. Therefore, the cooling plate 450 integrally formed by extrusion of the 5 series aluminum material can have a better hardness than the cooling plate 150. The cooling plate 450 is arranged in the middle of the housing 101 of the battery pack 100, in addition to cooling the battery units on both sides thereof, the cooling plate 450 can also function to support the housing 101 and the battery units 110, so as to better prevent deformation of the battery pack during transportation and installation.

In addition, in this embodiment, the front sealing plate 461, the rear scaling plate 462, the pair of adapters 468, 469, the inlet pipe 457, the outlet pipe 458 and the end plate 485 are all connected by means of a laser welding process. Compared with a friction welding process generally used for the 5 series aluminum material, the laser welding process requires less welding space and welding thickness, and the welding is also very firm.

According to different cooling requirements, other numbers of intermediate partition plates may also be provided in this embodiment. In addition, the partition plate may not be configured in the shape of a flat plate, but may be formed into other shapes by extrusion, so as to form a fluid channel of other shapes.

In the battery pack of various embodiments of the present disclosure, the cooling plate is arranged in the middle of the housing, and the plurality of battery units are arranged on the two sides of the cooling plate. This makes the structure of the battery pack compact while ensuring the number of battery units, and also makes each battery unit in contact with the cooling plate, so that the heat dissipation area of the cooling plate is increased. In addition, the cooling plate being integrally formed by extrusion of the 5 series aluminum material can make the strength of the cooling plate better. When the cooling plate is arranged in the middle of the housing, the cooling plate can also be used as a structural member to support the housing and improve the rigidity of the battery pack.

For different vehicle working environments, different vehicle types, or different battery installation locations, different battery cooling methods may be required. The cooling plates of various embodiments of the present disclosure have a modular assembly structure. It is possible to replace only the corresponding accessories in the cooling plate according to the requirements for different cooling medium or cooling methods. For example, only the inlet pipe and the outlet pipe need to be replaced, to satisfy the requirements for different cooling medium or cooling methods. Therefore, for the manufacturer of the cooling plate, there is no need to set up additional molds for batteries and cooling plates suitable for different cooling methods, so that machining is more convenient.

Although the present disclosure is described in conjunction with the examples of embodiments outlined above, various alternatives, modifications, variations, improvements, and/or substantial equivalents that are known or currently available or to be contemplated before long may be obvious to those with at least ordinary skill in the art. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements, and/or substantial equivalents. The technical effects and technical problems in this specification are exemplary rather than limiting. It should be noted that the embodiments described in this specification may have other technical effects and can solve other technical problems.

1. A cooling plate, comprising:
a cooling plate body comprising a first side plate, a second side plate and a fluid channel, the first side plate and the second side plate being disposed facing each other and a cavity being formed between the first side plate and the second side plate, the fluid channel being provided in the cavity between the first side plate and the second side plate, and the fluid channel having an inlet and an outlet;
an inlet pipe in fluid communication with the inlet of the fluid channel, and an outlet pipe in fluid communication with the outlet of the fluid channel; and
the first side plate, the second side plate and the fluid channel in the cooling plate body being integrally formed by extrusion.

2. The cooling plate according to claim 1, wherein the first side plate and the second side plate are made of a 5 series aluminum material.

3. The cooling plate according to claim 2, further comprising a plurality of partition plates, the plurality of partition plates being laterally disposed in the cavity between the first side plate and the second side plate and configured to form the fluid channel in a curved shape between the first side plate and the second side plate, wherein the plurality of partition plates, the first side plate and the second side plate are integrally formed by extrusion.

4. The cooling plate according to claim 3, further comprising a front sealing plate connected to front ends of the first side plate and the second side plate, and a rear sealing plate connected to rear ends of the first side plate and the second side plate, wherein the plurality of partition plates include a top partition plate, at least one intermediate partition plate and a bottom partition plate, the top partition plate and the bottom partition plate being both connected to the front sealing plate and the rear sealing plate, and the at least one intermediate partition plate is connected to one of the front sealing plate and the rear sealing plate and spaced apart from the other of the front sealing plate and the rear sealing plate, so that the plurality of partition plates form the fluid channel in a curved shape between the first side plate and the second side plate.

5. The cooling plate according to claim 4, wherein the rear sealing plate comprises an inlet hole matching the shape of the inlet of the fluid channel and being in fluid communication with the inlet of the fluid channel, and an outlet hole matching the shape of the outlet of the fluid channel and being in fluid communication with the outlet of the fluid channel.

6. The cooling plate according to claim 5, wherein the front ends of the first side plate and the second side plate have respective frontend faces, the rear ends of the first side plate and the second side plate have respective rear end faces, and the front sealing plate and the rear sealing plate are respectively connected to the front end faces and the rear end faces of the first side plate and the second side plate by means of a laser welding process.

7. The cooling plate according to claim 5, further comprising:
a first adapter and a second adapter, through which the inlet pipe and the outlet pipe are respectively in fluid communication with the inlet and outlet of the fluid channel, wherein the first adapter and the second adapter respectively have a first adapter channel and a second adapter channel, wherein a first end of the first adapter channel matches the shape of the inlet of the fluid channel, and a second end of the first adapter channel matches the shape of the inlet pipe, and wherein a first end of the second adapter channel matches the shape of the outlet of the fluid channel, and a second end of the second adapter channel matches the shape of the outlet pipe.

8. The cooling plate according to claim 7, wherein the first adapter and the second adapter are connected to the rear sealing plate by means of a laser welding process, and are connected to the inlet pipe or the outlet pipe by means of a laser welding process.

9. The cooling plate according to claim 7, further comprising an end plate, wherein the end plate extends perpendicular to the first side plate and the second side plate, and the end plate is connected to at least one of the first adapter, the second adapter, the inlet pipe and the outlet pipe by means of a laser welding process.

10. The cooling plate according to claim 9, wherein the end plate comprises sleeve tubes, through which the end plate is connected to the first adapter, the second adapter, the inlet pipe and the outlet pipe.

11. The cooling plate according to claim 1, wherein the cooling plate is mounted in a battery pack which comprises:
a plurality of battery units including a first group of battery units in contact with the first side plate of the cooling plate and a second group of battery units in contact with the second side plate of the cooling plate.

12. A battery pack, comprising:
a housing having a chamber;
a cooling plate, the cooling plate being disposed in the chamber in a front-rear direction, the cooling plate comprising:
a cooling plate body comprising a first side plate, a second side plate and a fluid channel, the first side plate and the second side plate being disposed facing each other and a cavity being formed between the first side plate and the second side plate, the fluid channel being provided in the cavity between the first side plate and the second side plate, and the fluid channel having an inlet and an outlet;
an inlet pipe in fluid communication with the inlet of the fluid channel, and an outlet pipe in fluid communication with the outlet of the fluid channel; and
the first side plate, the second side plate and the fluid channel in the cooling plate body being integrally formed by extrusion; and
a plurality of battery units including a first group of battery units which are in contact with the first side plate of the cooling plate and disposed in the chamber on a first side of the cooling plate, and a second group of battery units which are in contact with the second side plate of the cooling plate and disposed in the chamber on a second side of the cooling plate.

13. The cooling plate according to claim 1, further comprising a plurality of partition plates, the plurality of partition plates being laterally disposed in the cavity between the first side plate and the second side plate and configured to form the fluid channel in a curved shape between the first side plate and the second side plate, wherein the plurality of partition plates, the first side plate and the second side plate are integrally formed by extrusion.

14. The cooling plate according to claim 13, further comprising a front sealing plate connected to front ends of the first side plate and the second side plate, and a rear sealing plate connected to rear ends of the first side plate and the second side plate, wherein the plurality of partition plates include a top partition plate, at least one intermediate partition plate and a bottom partition plate, the top partition plate and the bottom partition plate being both connected to the front sealing plate and the rear sealing plate, and the at least one intermediate partition plate is connected to one of the front sealing plate and the rear sealing plate and spaced apart from the other of the front sealing plate and the rear sealing plate, so that the plurality of partition plates form the fluid channel in a curved shape between the first side plate and the second side plate.

15. The cooling plate according to claim 14, wherein the rear sealing plate comprises an inlet hole matching the shape of the inlet of the fluid channel and being in fluid communication with the inlet of the fluid channel, and an outlet hole matching the shape of the outlet of the fluid channel and being in fluid communication with the outlet of the fluid channel.

16. The cooling plate according to claim 4, wherein the front ends of the first side plate and the second side plate have respective frontend faces, the rear ends of the first side plate and the second side plate have respective rear end faces, and the front sealing plate and the rear sealing plate are respectively connected to the front end faces and the rear end faces of the first side plate and the second side plate by means of a laser welding process.

17. The battery pack according to claim 12, wherein the cooling plate further comprises a plurality of partition plates, the plurality of partition plates being laterally disposed in the cavity between the first side plate and the second side plate and configured to form the fluid channel in a curved shape between the first side plate and the second side plate, wherein the plurality of partition plates, the first side plate and the second side plate are integrally formed by extrusion.

18. The battery pack according to claim 12, wherein the cooling plate further comprises a front sealing plate connected to front ends of the first side plate and the second side plate, and a rear sealing plate connected to rear ends of the first side plate and the second side plate, wherein the plurality of partition plates include a top partition plate, at least one intermediate partition plate and a bottom partition plate, the top partition plate and the bottom partition plate being both connected to the front sealing plate and the rear sealing plate, and the at least one intermediate partition plate is connected to one of the front sealing plate and the rear sealing plate and spaced apart from the other of the front sealing plate and the rear sealing plate, so that the plurality of partition plates form the fluid channel in a curved shape between the first side plate and the second side plate.

19. The battery pack according to claim 18, wherein the rear sealing plate comprises an inlet hole matching the shape of the inlet of the fluid channel and being in fluid communication with the inlet of the fluid channel, and an outlet hole matching the shape of the outlet of the fluid channel and being in fluid communication with the outlet of the fluid channel.

20. The battery pack according to claim 19, wherein the front ends of the first side plate and the second side plate have respective frontend faces, the rear ends of the first side plate and the second side plate have respective rear end faces, and the front sealing plate and the rear sealing plate are respectively connected to the front end faces and the rear end faces of the first side plate and the second side plate by means of a laser welding process.
